(19) United States
(12) Patent Application Publication
(10) Pub. No.: US 2014/0201619 A1
(43) Pub. Date: Jul. 17, 2014

(54) Method And Device For Implementing Local Operation On Web Page

(71) Applicant: Beijing Lenovo Software Ltd., Beijing (CN)

(72) Inventors: Hongling Mo, Beijing (CN); Jing Li, Beijing (CN); Jing Xu, Beijing (CN); Rongfeng Feng, Beijing (CN); Weifeng Zhuang, Beijing (CN); Kang Chen, Beijing (CN); Zhong Chen, Beijing (CN)

(73) Assignee: Beijing Lenovo Software Ltd., Beijing (CN)

(21) Appl. No.: 14/153,484

(22) Filed: Jan. 13, 2014

(30) Foreign Application Priority Data
Jan. 11, 2013 (CN) 201310011380.4
Jan. 14, 2013 (CN) 201310012912.6
Jan. 18, 2013 (CN) 201310020350.X

(51) Int. Cl. G06F 17/22

(52) U.S. Cl. CPC G06F 17/2247
USPC 715/234

(57) ABSTRACT

A method and device for implementing a local operation on a web page are disclosed, which belong to the field of web technology. The method is applied to an electronic apparatus that includes a displaying unit and has an HTML operating environment. The method includes loading a web page in the HTML operating environment by address information; obtaining identification information for representing a status of local resources of the electronic apparatus, in the process of loading the web page; obtaining an operation request for representing a request for operating a first resource in the local resources; responding to the operation request with the first resource; and displaying a responding result of the responding to the operation request with the first resource on the displaying unit. The present method and device implement executing local operation on the web page, which improves the local calling capacity of a javascript code.

This application claims priority to Chinese patent application No. 201310011380.4 filed Jan. 11, 2013; Chinese patent application No. 201310012912.6 filed Jan. 14, 2013; and Chinese patent application No. 201310020350.X filed Jan. 18, 2013; the entire contents of which are incorporated herein by reference.

### BACKGROUND

The present disclosure relates to a field of web technology, and more particularly, to a method and device for implementing a local operation on a web page.

JavaScript is an object-based and event driven client-side scripting language with relative safety, which is applied widely in the client-side Web development. JavaScript is frequently used to add dynamic functions to a Hyper Text Markup Language (HTML) webpage, such as various operations in response to a user, etc. JavaScript can also be used on other occasions, such as server-side programming, etc.

A JavaScript engine is an interpreter able to read and execute JavaScript source code, which is mostly applied in a web browser at present, such as Nitro of Apple Safari 4, V8 of Chrome browser, TraceMonkey of Mozilla Firefox 3.5, etc.

In a Chrome browser, a Javascript engine V8 is responsible for parsing and running Javascript code. For the sake of safety, when the JavaScript engine V8 is operating in a render progress of the Chrome browser, the render progress is usually set in a sandbox, to restrict the Javascript code to be run only in the sandbox, thereby enhancing the safety of the browser.

However, since the Javascript code can be run only in the sandbox, the Javascript code on the web page has a very weak capacity to execute local calling. Currently, the access to a local file has not been realized yet.

Currently, multiple electronic apparatuses are configured with one or more kinds of sensors, such as a gravity sensor, a gyroscope, an optical sensor, a magnetic field sensor, a temperature sensor, etc. The local applications of the multiple electronic apparatuses have utilized these sensors; however, Web application has not used such sensors yet. HTML5 of W3C defines that obtaining the local sensor data which is based on the Web application of HTML5 is implemented by accessing an apparatus API of the sensor apparatus. However, if the user wants to use a sensor of other apparatus by remote operation, for example, to use a sensor on the mobile phone from a personal computer without a sensor, there is no corresponding solution at present. In addition, in the prior art, the access to multimedia stream by a browser still cannot be truly realized on some operating system platforms of some electronic apparatuses.

### SUMMARY

In order to improve the local calling capacity of the Javascript code, the present disclosure provides a method and device for implementing a local operation on a web page. The technical solutions are as follows.

In one aspect, the present disclosure provides a method for implementing a local operation on a web page. The method is applied to an electronic apparatus, the electronic apparatus includes a displaying unit, and the electronic apparatus has a HyperText Markup Language (HTML) operating environment. The method includes: loading a web page in the HTML operating environment according to address information; obtaining identification information for representing a status of local resources of the electronic apparatus, in the process of loading the web page; obtaining an operation request, the operation request being used for representing a request for operating a first resource in the local resources; responding to the operation request with the first resource according to the operation request; displaying a responding result of the responding to the operation request with the first resource on the displaying unit.

The responding to the operation request with the first resource according to the operation request includes: when a javascript engine parses a first interface corresponding to the operation request in the render progress, the javascript engine being used for interpreting a javascript script, the first interface is an interface self-defined based on javascript and used for operating the first resource on the web page, and the first interface is registered in the javascript engine, the javascript engine transmitting an inter-process communication (IPC) message to a host process according to the first interface to request for operating the local first resource on the web page. During the host process, a local interface is called according to the received IPC message so as to operate the local first resource on the web page. The render progress is in a protected state and has no authority to call the local interface; and the host process is in a non-protected state and has an authority to call the local interface.

The javascript engine transmitting an IPC message to a host process according to the first interface to request for operating the local first resource on the web page includes: mapping, by the javascript engine, the first interface as a local function able to run in the render process; running the local function, and transmitting the IPC message to the host process, to request for operating the local first resource on the web page.

The method further includes: judging whether the web page has an authority to operate the local resources or not according to a preset white list, before the javascript engine transmits an inter-process communication (IPC) message to the host process according to the first interface; executing the step of the javascript engine transmitting the IPC message to the host process according to the first interface, if it is determined that the web page has the authority to operate the local resources.

In the method for implementing the local operation on the web page, the electronic apparatus may include a sensor, and the obtained operation request may be a sensor data request received from a remote electronic apparatus which is connected with the electronic apparatus. The responding to the operation request with the first resource according to the operation request may include: parsing the sensor data request, to obtain a sensor application interface corresponding to the sensor data request; obtaining sensor data from the sensor corresponding to the sensor application interface; transmitting, by the Web application, the obtained sensor data to the remote electronic apparatus.

In the method for implementing the local operation on the web page, the HTML operating environment may be an HTML5 operating environment, the obtained operation request may be a sensor data request transmitted by the Web application, the responding to the operation request with the first resource according to the operation request may include: parsing the sensor data request, to obtain a sensor application interface corresponding to the sensor data request; inquiring a local application interface, if the local application interface corresponding to the obtained sensor application interface exists, obtaining the sensor data from the local application interface and providing it to the Web application; if the local application interface corresponding to the obtained sensor application interface does not exist, transmitting the sensor data request including the obtained sensor application interface to the remote electronic apparatus, and receiving the sensor data returned from the remote electronic apparatus.

In the method for implementing the local operation on the web page, the method enables a browser installed in the electronic apparatus to realize real-time play of a multimedia stream, and the responding to the operation request with the first resource according to the operation request may include: obtaining a multimedia stream via a multimedia interface as the first resource; converting the multimedia stream into a resource address in a specific format; playing the multimedia stream by accessing the resource address in the browser.

In the method for implementing the local operation on the web page, the step of obtaining a multimedia stream via a multimedia interface may include: inquiring a state of a multimedia capture device in the electronic apparatus via the multimedia interface; obtaining the multimedia stream captured by the multimedia capture device via the multimedia interface, when the multimedia capture device is in a working state; and storing the multimedia stream in a memory address.

In the method for implementing the local operation on the web page, the step of converting the multimedia stream into a resource address in a specific format may include: generating the resource address; pairing the memory address with resource address, registering the pairing in a mapping file.

In the method for implementing the local operation on the web page, the step of playing the multimedia stream by accessing the resource address in the browser may include: defining a display area in the browser according to location information and attribute information; allocating the resource address to the display area; and playing the multimedia stream by accessing the resource address in the display area.

In the method for implementing the local operation on the web page, the step of playing the multimedia stream by accessing the resource address in the display area may include: judging whether the resource address allocated to the display area has a specific format or not; if does, inquiring the memory address of the multimedia stream corresponding to the resource address in the mapping file; reading the multimedia stream from the memory address; and displaying the multimedia stream in the display area.

In another aspect, the present disclosure further provides a method for implementing a local operation on a web page. The method is applied to an electronic apparatus, and the electronic apparatus has a HTML operating environment. The method includes: when a web page is opened in the HTML operating environment, the javascript engine parsing the web page in a render process; when the javascript engine parses a first interface, the first interface being an interface self-defined based on a javascript, being used for operating the local first resource on the web page, and being registered in the javascript engine, the javascript engine transmitting an inter-process communication (IPC) message to a host process according to the first interface to request for operating the local first resource on the web page.

During the host process, calling a local interface to operate the local first resource on the web page according to the received IPC message during the host process. The render progress is in a protected state and has no authority to call the local interface; the host process is in a non-protected state and has an authority to call the local interface.

The javascript engine transmitting an inter-process communication (IPC) message to a host process according to the first interface so as to request for operating the local first resource on the web page may includes: mapping, by the javascript engine, the first interface as a local function able to be run in the render process; running the local function, and transmitting the IPC message to the host process, to request for operating the local first resource on the web page.

The method may further includes: judging whether the web page has an authority to operate the local resources or not according to a preset white list, before the javascript engine transmitting an inter-process communication (IPC) message to a host process according to the first interface; executing the step of the javascript engine transmitting the IPC message to the host process according to the first interface, if it is determined that the web page has the authority to operate the local resources.

The calling a local interface to operate the local first resource on the web page according to the received IPC message during the host process may includes: during the host process, filtering the IPC message received by the host process, and after it is determined that the IPC message is a message handled by the host process, calling the local interface to operate the local first resource on the web page according to the IPC message.

In still another aspect, the present disclosure further provides a device for implementing a local operation on a web page, the device is applied to an electronic apparatus, and the electronic apparatus has a HTML operating environment. The device includes: a loading unit, for loading a web page in the HTML operating environment according to address information; an obtaining unit, for obtaining identification information for representing a status of local resources of the electronic apparatus in the process of loading the web page; a responding unit, for obtaining an operation request, the operation request being used for representing a request for operating a first resource of the local resources, and for responding to the operation request with the first resource according to the operation request; a displaying unit, for displaying a responding result of the responding to the operation request with the first resource.

The responding unit includes: a javascript engine, for interpreting a javascript script when a first interface corresponding to the operation request is parsed in the render progress, wherein the first interface is an interface self-defined based on javascript and used for operating the first resource on the web page, and the first interface is registered in the javascript engine, and for transmitting an inter-process communication (IPC) message to a host process according to the first interface, to request for operating the local first resource on the web page; a local calling subunit, for calling a local interface to operate the local first resource on the web page according to the received IPC message during the host process. The render progress is in a protected state and has no authority to call the local interface; the host process is in a non-protected state and has an authority to call the local interface.

The javascript engine is used for: mapping the first interface as a local function able to be run in the render process; running the local function, and transmitting the IPC message to the host process, to request for operating the local first resource on the web page.

The javascript engine may be further used for: judging whether the web page has an authority to operate the local resources or not according to a preset white list, before transmitting the inter-process communication (IPC) message to the host process according to the first interface; executing the step of the javascript engine transmitting the IPC message to the host process according to the first interface, if it is determined that the web page has the authority to operate the local resources.

In the device for implementing the local operation on the web page, the HTML operating environment may be an HTML5 operating environment, and the responding unit may include: a processing unit, for running at least one HTML5-based Web application; a communication unit, for conducting a communication connection with a remote electronic apparatus via a network; wherein, the processing unit may further include a parsing module and a sensor proxy module, the analyzing module may receive and parse a sensor data request transmitted by the Web application run by the processing unit, to obtain a sensor application interface corresponding to the sensor data request, and the sensor proxy module may inquire a local application interface, if the local application interface corresponding to the obtained sensor application interface exists, obtaining sensor data from the local application interface and providing the sensor data to the Web application, if the local application interface corresponding to the obtained sensor application interface does not exist, transmit the sensor data request including the obtained sensor application interface to the remote electronic apparatus, and receive the sensor data returned from the remote electronic apparatus.

In the device for implementing the local operation on the web page, the electronic apparatus may also include a sensor unit, wherein, the Web application run by the processing unit may receive the sensor data request of the remote electronic apparatus via the communication unit, obtain the sensor data from a sensor corresponding to the sensor application interface, and the Web application transmits the obtained sensor data to the remote electronic apparatus via the communication unit.

In the device for implementing the local operation on the web page, the device enables a browser installed in the electronic apparatus to realize real-time play of multimedia stream, and the responding unit may include: an obtaining unit, for obtaining a multimedia stream via a multimedia interface; a converting unit, for converting the multimedia stream into a resource address in a specific format; and a playing unit, for playing the multimedia stream by accessing the resource address in the browser.

In the device for implementing the local operation on the web page, the obtaining unit may include: an inquiring module, for inquiring a state of a multimedia capture device in the electronic apparatus via the multimedia interface; an obtaining module, for obtaining the multimedia stream captured by the multimedia capture device via the multimedia interface, when the multimedia capture device is in a working state; and a memory module, for storing the multimedia stream in a memory address.

In the device for implementing the local operation on the web page, the converting unit may include: a generating module, for generating the resource address; a pairing module, for pairing the memory address with the resource address; and a registering module, for registering the pairing in a mapping file.

In the device for implementing the local operation on the web page, the playing unit may include: a defining module, for defining a display area in the browser according to location information and attribute information; an allocating module, for allocating the resource address to the display area; and a playing module, for playing the multimedia stream by accessing the resource address in the display area.

In the device for implementing the local operation on the web page, the playing module may judge whether the resource address allocated to the display area has the specific format or not; if does, inquire the memory address of the multimedia stream corresponding to the resource address in the mapping file, read the multimedia stream from the memory address, and display the multimedia stream in the display area.

In yet another aspect, the present disclosure further provides a device for implementing a local operation on a web page, the device is applied to an electronic apparatus, and the electronic apparatus has a HTML operating environment. The device includes: a javascript engine, for parsing a web page in the render process when the web page is opened in the HTML operating environment, for, when a first interface is parsed, transmitting an inter-process communication (IPC) message to a host process according to the first interface to request for operating the local first resource on the web page, the first interface is an interface self-defined based on javascript and is used for operating the first resource on the web page, and the first interface is registered in the javascript engine; a local calling module, for calling a local interface to operate the local first resource on the web page according to the received IPC message during the host process. The render progress is in a protected state and has no authority to call the local interface; the host process is in a non-protected state and has an authority to call the local interface.

The javascript engine may be used for: mapping the first interface as a local function able to be run in the render process; running the local function, and transmitting the IPC message to the host process, to request for operating the local first resource on the web page.

The javascript engine may be further used for: judging whether the web page has an authority to operate the local resources or not according to a preset white list, before the inter-process communication (IPC) message is transmitted to a host process according to the first interface; executing the step of transmitting the IPC message to the host process according to the first interface, if it is determined that the web page has the authority to operate the local resources.

The local calling module is used for: during the host process, filtering the IPC message received by the host process, after it is determined that the IPC message is a message handled by the host process, calling the local interface to operate the local first resource on the web page according to the IPC message.

The advantageous effects brought by the technical solutions provided by the present disclosure are: in one aspect, when a web page is loaded according to the address information in the HTML operating environment, identification information for representing a status of local resources of the electronic apparatus is obtained, an operation request is obtained which is used for representing a request for operating the first resource in the local resources; the operation request is responded with the first resource according to the operation request, and a responding result of the responding to the operation request with the first resource is displayed on the displaying unit, thereby it realizes the access to and operation of the local resources on the web page, which improves the local calling capacity of the javascript code. In another aspect, when a web page is opened in the HTML operating environment, after the javascript has parsed the registered first interface in the render process, an IPC message is transmitted to the host process, operating the local first resource on the web page is requested; a local interface for operating the local first resource on the web page is called according to the IPC message during the host process, so that the operation of the local first resource on the web page is responded, it improves the local calling capacity of the javascript code. As compared with the prior art, the interface of local calling is opened for the web page, the local operation function of the web page is added, and the javascript self-defined interface is not restricted to file reading or writing operations, but can execute various local operations according to design, which is flexible, convenient and widely applicable.

### BRIEF DESCRIPTION OF THE DRAWINGS

In order to illustrate the technical solution in the embodiments of the present disclosure more clearly, the drawings necessary for description of the embodiments or the prior art shall be briefly explained as follows. Apparently, the drawings in the following description are merely some embodiments of the present disclosure, from which one ordinarily skilled in the art still can obtain other drawings without inventive effort.

FIG. 1 is a flow chart of a method for implementing a local operation on a web page according to an embodiment of the present disclosure;

FIG. 2 is a flow chart of a method for implementing a local operation on a web page according to another embodiment of the present disclosure;

FIG. 3 is a flow chart of a method for implementing a local operation on a web page according to still another embodiment of the present disclosure;

FIG. 4 is a schematic diagram of implementing a local operation by inter-process interaction according to an embodiment of the present disclosure;

FIG. 5 is schematic structure diagram of a device for implementing a local operation on a web page according to an embodiment of the present disclosure;

FIG. 6 is schematic structure diagram of a device for implementing a local operation on a web page according to another embodiment of the present disclosure;

FIG. 7 is a structural schematic diagram of the principle of the electronic apparatus according to an embodiment of the present disclosure;

FIG. 8 is a flow chart of a sensor data obtaining process of a sensor data obtaining method according to an embodiment of the present disclosure;

FIG. 9 is a flow chart of a sensor data providing process of a sensor data obtaining method according to an embodiment of the present disclosure;

FIG. 10 shows an information processing method of the present disclosure;

FIG. 11 shows an information processing device of the present disclosure;

FIG. 12 shows an information processing method according to an embodiment of the present disclosure;

FIG. 13 shows an information processing device according to an embodiment of the present disclosure;

FIG. 14 shows a framework for realizing network real-time communication defined in WebRTC protocol.

FIG. 15 shows an example of a program code for implementing the information processing method according to an embodiment of the present disclosure;

FIG. 16 shows a media callback information defined in WebRTC protocol.

### DETAILED DESCRIPTION

In order to make the objective, technical solutions, and advantages of the present disclosure clearer, the embodiments of the present disclosure are further described in detail hereinafter in conjunction with the accompanying drawings.

The embodiments of the present disclosure relate to an HTML operating environment. The HTML operating environment indicates a multi-process operating environment with safety protection. In the HTML operating environment, a presentation engine is responsible for presenting HTML documents and pictures, and a javascript engine is responsible for interpreting a javascript script. The presentation engine is, for example, webkit, Gecko, etc. The multi-process indicates a plurality of processes run simultaneously to execute tasks in the HTML operating environment, and the multi-process includes, but not limited to, a render process, a host (rower) process, etc. The safety protection indicates that the render process in the HTML operating environment is in a protected status, having no authority to call the local interface. For example, it is set in the sandbox, and complies with a principle of minimum permissions, and the authority of each processing action will be restricted; moreover, merely computation is allowed, but writing into a file or reading a file from a sensitive area such as My document, desktop, etc. are not allowed, so as to restrict the Javascript code in the web page only to be run in the sandbox, so that a malicious software is unable to steal a credit card number, or to interfere with the mouse operation, etc., thereby improving safety. The HTML operating environment may be a browser, including, but not limited to, a Chrome browser, etc.

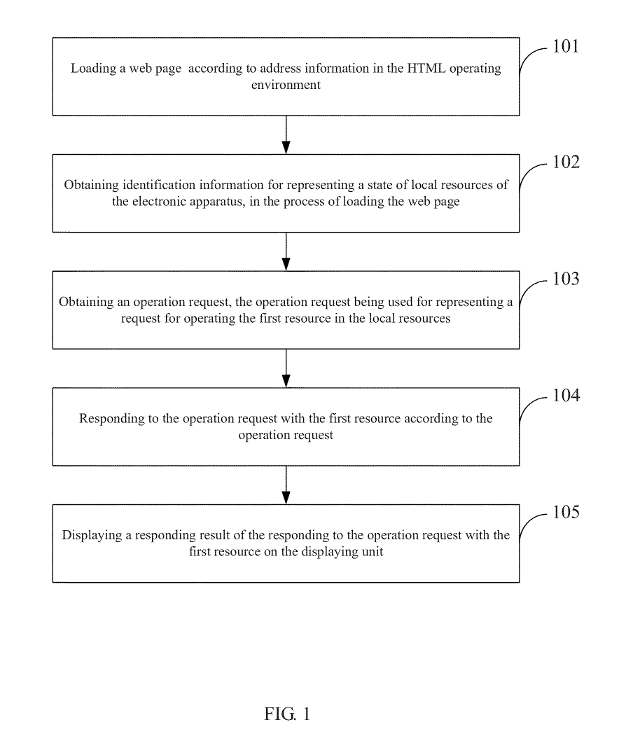

Referring to FIG. 1, an embodiment of the present disclosure provides a method for implementing a local operation on a web page, wherein the method is applied to an electronic apparatus, the electronic apparatus includes a displaying unit, and the electronic apparatus has a HyperText Markup Language (HTML) operating environment. The method includes:
101: Loading a web page in the HTML operating environment according to address information;
102: Obtaining identification information for representing a status of local resources of the electronic apparatus, in the process of loading the web page;
103: Obtaining an operation request, the operation request being used for representing a request for operating a first resource in the local resources;
104: Responding to the operation request with the first resource according to the operation request;
105: Displaying a responding result of the responding to the operation request with the first resource on the displaying unit.

In one embodiment of the above method, specifically, step 102 may include: in the process of loading the web page, when a javascript engine parses a second interface in the render progress, the javascript engine is used for interpreting a javascript script, wherein the second interface is an interface self-defined based on a javascript and is used for obtaining identification information for representing a status of local resources of the electronic apparatus, and the second interface is registered in the javascript engine, then the javascript engine transmits an inter-process communication (IPC) message to a host process according to the second interface, to request for obtaining the identification information; and calling the identification information obtained by the local interface according to the received IPC message in the host process.

Correspondingly, in the above method, a display interface corresponding to the web page may be displayed on the displaying unit, and a corresponding result is displayed on the display interface after the operation request is responded with the first resource according to the operation request.

In another embodiment of the above method, specifically, a display interface corresponding to the web page may be firstly displayed on the displaying unit, and the identification information may be displayed on the display interface. The identification information includes at least a first identification corresponding to the first resource, and may further include more identifications, such as a second identification corresponding to a second resource, or a third identification corresponding to a third resource, etc. The operation request may be obtained by detecting whether the identification on the display interface is triggered or not; for example, when it is detected that the first identification on the display interface is triggered, the operation request is obtained, which is used for representing a request for operating the first resource in the local resources. The corresponding result is displayed on the display interface after the operation request is responded with the first resource.

In the present embodiment, the responding to the operation request with the first resource according to the operation request includes:
When the javascript engine parses the first interface corresponding to the operation request in the render progress, the javascript engine being used for interpreting a javascript script, wherein the first interface is an interface self-defined based on javascript and is used for operating the first resource on the web page, and the first interface is registered in the javascript engine, then the javascript engine transmitting an inter-process communication (IPC) message to a host process, to request for operating the local first resource on the web page;
Calling a local interface to operate the local first resource on the web page according to the received IPC message during the host process;
Wherein, the render progress is in a protected state and has no authority to call the local interface; the host process is in a non-protected state and has an authority to call the local interface.

Further, the javascript engine transmitting the IPC message to a host process according to the first interface, to request for operating the local first resource on the web page, includes:
Mapping, by the javascript engine, the first interface as a local function able to run in the render process;
Running the local function, and transmitting the IPC message to the host process, to request for operating the local first resource on the web page.

In the present embodiment, the method further includes:
Judging whether the web page has an authority to operate the local resources or not according to a preset white list, before the javascript engine transmitting an inter-process communication (IPC) message to a host process according to the first interface;
Executing the step of the javascript engine transmitting the IPC message to the host process according to the first interface, if it is determined that the web page has the authority to operate the local resources.

In the above method provided by the present embodiment, when the web page is loaded according to the address information in the HTML operating environment, obtaining identification information for representing a status of local resources of the electronic apparatus; and obtaining an operation request, the operation request being used for representing a request for operating the first resource in the local resources, responding to the operation request with the first resource, and displaying a responding result of the responding to the operation request with the first resource on the displaying unit, and thus the access to and operation of the local resources on the web page are realized, which improves the local calling capacity of the javascript code.

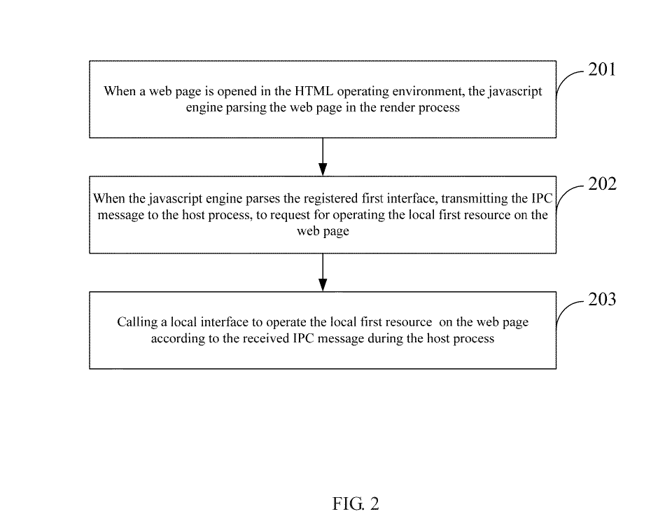

Referring to FIG. 2, another embodiment of the present disclosure provides a method for implementing a local operation on a web page, wherein the method is applied to an electronic apparatus, and the electronic apparatus has an HTML operating environment. The method includes:
201: When a web page is opened in the HTML operating environment, the javascript engine parsing the web page in a render process;
202: When the javascript engine parses the first interface, wherein the first interface is an interface self-defined based on javascript and is used for operating the local first resource on the web page, and the first interface is registered in the javascript engine, the javascript engine transmitting the IPC message to the host process according to the first interface, to request for operating the local first resource on the web page;
203: Calling the local interface to operate the local first resource on the web page according to the received IPC message during the host process;
Wherein, the render progress is in a protected state and has no authority to call the local interface; the host process is in a non-protected state and has an authority to call the local interface.

In the present embodiment, the javascript engine transmitting the inter-process communication (IPC) message to a host process according to the first interface, to request for operating the local first resource on the web page, includes:
Mapping, by the javascript engine, the first interface as a local function able to run in the render process;
Running the local function, and transmitting the IPC message to the host process, requesting to operate the local first resource on the web page.

In the present embodiment, the method further includes:
Judging whether the web page has an authority to operate the local resource or not according to a preset white list, before the javascript engine transmitting an inter-process communication IPC message to a host process according to the first interface;
Executing the step of the javascript engine transmitting the IPC message to the host process according to the first interface, if it is determined that the web page has the authority to operate the local resources.

In the present embodiment, the calling the local interface to operate the local first resource on the web page according to the received IPC message, includes: during the host process, filtering the IPC message received by the host process, after it is determined that the IPC message is a message processed by the host process, calling the local interface to operate the local first resource on the web page according to the IPC message.

In the above method provided by the present embodiment, when a web page is opened in the HTML operating environment, and after the javascript engine has parsed the registered first interface in the render process, an IPC message is transmitted to the host process, to request for operating the local first resource on the web page; calling the local interface to operate the local first resource on the web page according to the IPC message during the host process, so that the operation of the local first resource on the web page is responded, which improves the local calling capacity of the javascript code. And as compared with the prior art, the interface of local calling is opened for the web page, the local operation function of the web page is added, and the javascript self-defined interface is not restricted to file reading or writing operations, but can execute various local operations according to design, which is flexible, convenient and widely applicable.

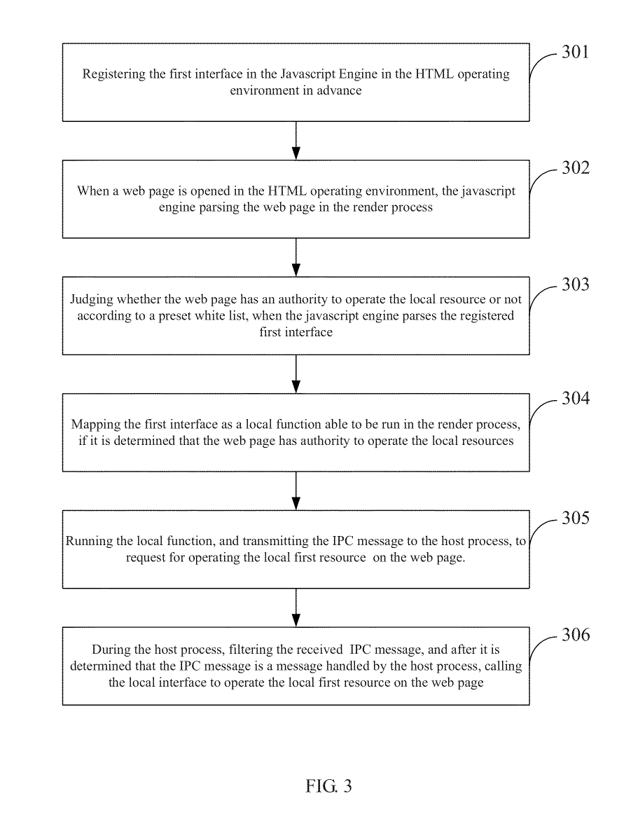

Referring to FIG. 3, another embodiment of the present disclosure provides a method for implementing a local operation on a web page, wherein the method is applied to an electronic apparatus, and the electronic apparatus has an HTML operating environment. The method specifically includes steps as follows.

301: Registering a first interface to a javascript engine in the HTML operating environment in advance, wherein the javascript engine is used for interpreting the javascript script, and the first interface is an interface self-defined based on javascript and is used for operating the local first resource on the web page. The first interface is designed in advance, the function of which is operating the local first resource on the web page. The web page indicates a page processed in the HTML operating environment, such as an html page currently displayed. The local first resource indicates a document, executable program, etc. saved on the local client-side. The operating the local first resource includes, but not limited to: reading a file in the client-side, writing a file to the client-side, executing an executable program, starting a service in the client-side, or forbidding a service in the client-side, etc.

302: When a web page is opened in the HTML operating environment, the javascript engine parsing the web page in a render process. The HTML operating environment in the present embodiment is a multi-process operating environment. The multi-process includes, but not limited to: a render process, a host (browser) process, etc., wherein, the javascript engine is operated in the render process, for example, the javascript engine V8 of the Chrome browser runs in the render process. The javascript engine is mainly used for parsing the javascript script in the web page.

303: the javascript engine judges whether the web page has an authority to operate the local resource or not according to a preset white list, when the javascript engine parses the registered first interface. In the present embodiment, the white list is a preset list, in which source information on the web page having the authority to operate the local resource is recorded. Specifically, whether the white list is recorded with the source information on the web page or not may be judged; if yes, it is determined that the web page has the authority to operate the local resource, otherwise, it is determined that the web page has no authority to operate the local resource. The authority of the web page for operating the local resource can be controlled strictly by the white list, so that safety is enhanced.

304: If it is determined that the web page has the authority to operate the local resources, mapping the first interface as a local function able to run in the render process. Usually, various local functions in the local function library may run in the render process. These functions are typically C++ functions, which can play various roles. The first interface can run in the render process only if it is mapped as a corresponding local function.

305: Running the local function, and transmitting an IPC message to the host process, to request for operating the local first resource on the web page. In the present embodiment, the render process is in the sandbox and is in the protected state, which cannot call various local interfaces to operate the local resources. Therefore, the render process will transmit the request for operating the local resources to the host process, so as to request the host process to operate the local resources. The IPC message is mainly used for communicating between processes, and there are many kinds of messages. In the present step, the IPC message is used for transmitting the request of operating the local resources to the host process, but the specific form of IPC message will not be described too much.

306: during the host process, filtering the IPC message received by the host process, calling the local interface to operate the local first resource on the web page according to the IPC message after it is determined that the received IPC message is a message handled by the host process.

Usually, the host process will receive many messages, various kinds of messages from different processes, wherein some messages belong to the messages handled by the host process, while other messages such as broadcast messages are not the messages handled by the host process; therefore, in order to improve processing efficiency, the host process may filter the received messages, so as to screen out the messages to be handled thereby. The host process is in a non-protected state and has an authority to call the local interface. Therefore, the local Application Programming Interface (API) may be called in the host process, so as to implement operation of the local resources. After the host process has operated the local first resource, the execution result will be returned to the render process.

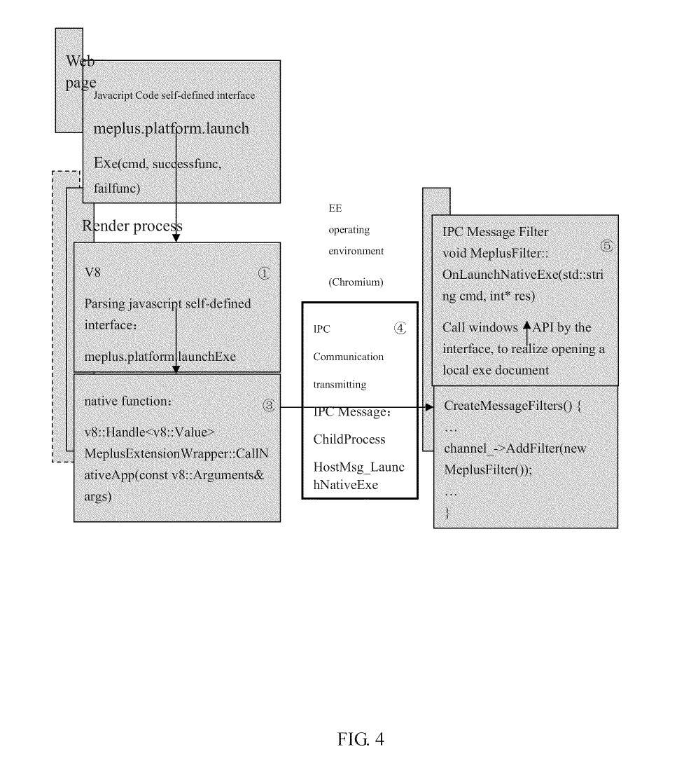

In order to better describe the execution procedure of the above method, referring to FIG. 4, a schematic diagram of realizing a local operation by inter-process interaction according to an embodiment of the present disclosure is depicted. In FIG. 4, the chromium browser is taken as an example of the HTML operating environment for the description. The web page running in the browser includes a javascript self-defined interface, which is for opening a local exe file on the client-side where the browser is located. The process of implementing the local operation is as follows: \textcircled{1} the JavaScript engine V8 parsing the javascript code on the web page in the render process, and parsing a javascript self-defined interface meplus.platform.lauchExe( ); \textcircled{2} mapping the javascript self-defined interface as a local function executable in the render process; \textcircled{3} running the local function; \textcircled{4} transmitting the IPC message to the host process, to request for performing the local operation; \textcircled{5} the host process filtering the received message, determining that the IPC message is a message handled by itself, and calling the function OnLaunchNativeExe( ) executable in the host process, and the function is for calling the API provided by the windows system to implement the operation of opening the local exe file.

In the above method provided by the present embodiment, when a web page is opened in the HTML operating environment, and after the javascript has parsed the registered first interface, transmitting an IPC message to the host process, to request for operating the local first resource on the web page; calling a local interface to operate the local first resource on the web page according to the IPC message during the host process, so that the operation of the local first resource on the web page is responded, the local calling capacity of the javascript code is improved. And as compared with the prior art, the interface of local calling is opened for the web page, the local operation function of the web page is added, and the javascript self-defined interface is not restricted to file reading or writing operation, but various local operations can be executed according to design, which is flexible, convenient and widely applicable.

Referring to FIG. 5, still another embodiment of the present disclosure provides a device for implementing a local operation on a web page, the device is applied to an electronic apparatus, wherein the electronic apparatus has a HyperText Markup Language HTML operating environment. The device includes:
a loading unit 501, for loading a web page in the HTML operating environment according to address information;
an obtaining unit 502, for obtaining identification information for representing a status of local resources of the electronic apparatus, in the process of loading the web page;
a responding unit 503, for obtaining an operation request, the operation request being used for representing a request for operating a first resource in the local resources; and responding to the operation request with the first resource according to the operation request;
a displaying unit 504, for displaying a responding result of the responding to the operation request with the first resource.

The responding unit 503 includes:
a javascript engine, for interpreting a javascript script when a first interface corresponding to the operation request is parsed in the render progress, wherein the first interface is an interface self-defined based on javascript and is used for operating the first resource on the web page, and the first interface is registered in the javascript engine, and for transmitting an inter-process communication (IPC) message to a host process according to the first interface, to request for operating the local first resource on the web page;
a local calling subunit, for calling a local interface to operate the local first resource on the web page according to the received IPC message during the host process;
wherein, the render progress is in a protected state and has no authority to call the local interface; the host process is in a non-protected state and has an authority to call the local interface.

Further, the javascript engine is used for: mapping the first interface as a local function able to run in the render process; running the local function, and transmitting the IPC message to the host process, to request for operating the local first resource on the web page.

In the present embodiment, the javascript engine is further used for: judging whether the web page has an authority to operate the local resources or not according to a preset white list, before transmitting an inter-process communication (IPC) message to a host process according to the first interface; executing the step of the javascript engine transmitting the IPC message to the host process according to the first interface, if it is determined that the web page has the authority to operate the local resources.

The above device provided by the present embodiment can execute the method provided by any of the above method embodiments, the detailed procedure of which may be referred to the description in the method embodiments, and will not be repeated here.

In the above device provided by the present embodiment, when the web page is loaded according to the address information in the HTML operating environment, the identification information for representing a status of local resources of the electronic apparatus is obtained; and the operation request is obtained which is used for representing a request for operating the first resource in the local resources; the operation request is responded with the first resource; and the responding result of the responding to the operation request with the first resource is displayed on the displaying unit, so that the access to and operation of the local resources on the web page are realized, which improves the local calling capacity of the javascript code.

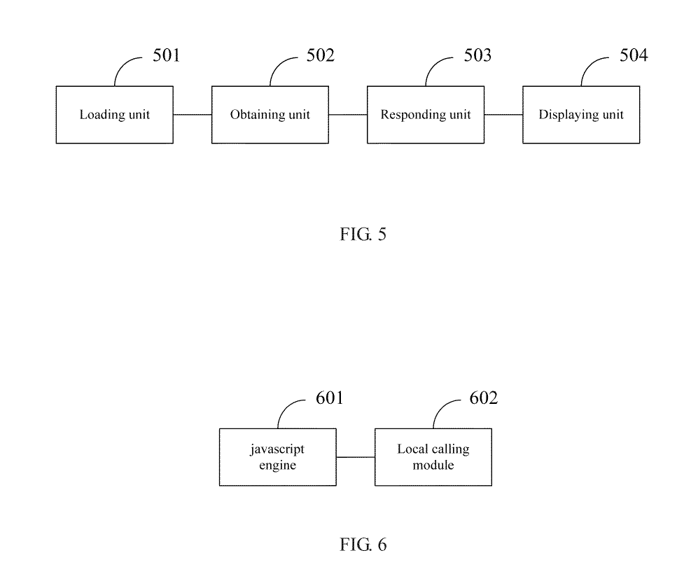

Referring to FIG. 6, another embodiment of the present disclosure provides a device for implementing a local operation on a web page, the device is applied to an electronic apparatus, wherein the electronic apparatus has a HyperText Markup Language HTML operating environment. The device includes:
a javascript engine 601, for parsing a web page in the render progress when the web page is opened in the HTML operating environment; when a first interface is parsed which is an interface self-defined based on javascript, is used for operating the first resource on the web page, and is registered in the javascript engine, transmitting an inter-process communication (IPC) message to a host process according to the first interface, to request for operating the local first resource on the web page;
a local calling module 602, for calling a local interface to operate the local first resource on the web page according to the received IPC message during the host process;
wherein, the render progress is in a protected state and has no authority to call the local interface; the host process is in a non-protected state and has an authority to call the local interface.

The javascript engine is used for: mapping the first interface as a local function able to run in the render process; running the local function, and transmitting the IPC message to the host process, to request for operating the local first resource on the web page.

The javascript engine is further used for: judging whether the web page has an authority to operate the local resources or not according to a preset white list, before transmitting an inter-process communication (IPC) message to a host process according to the first interface; executing the step of transmitting the IPC message to the host process according to the first interface, if it is determined that the web page has the authority to operate the local resources.

In the present embodiment, the local calling module is used for, during the host process, filtering the IPC message received by the host process, and, after the IPC message is affirmed as the message processed by the host process, calling the local interface to operate the local first resource on the web page according to the IPC message.

The above device provided by the present embodiment can execute the method provided by any of the above method embodiments, the detailed procedure of which may be referred to the description in the method embodiments, and will not be repeated here.

In the above device provided by the present embodiment, when a web page is opened in the HTML operating environment, and after the javascript has parsed the registered first interface in the render process, the IPC message is transmitted to the host process, to request for operating the local first resource on the web page; during the host process, a local interface is called according to the IPC message so as to operate the local first resource on the web page, so that the operation of the local first resource on the web page is responded, the local calling capacity of the javascript code is improved. And as compared with the prior art, the interface of local calling is opened for the web page, the local operation function of the web page is increased, and the javascript self-defined interface is not restricted to file reading or writing operations, but various local operations can be executed according to design, which is flexible, convenient and widely applicable.

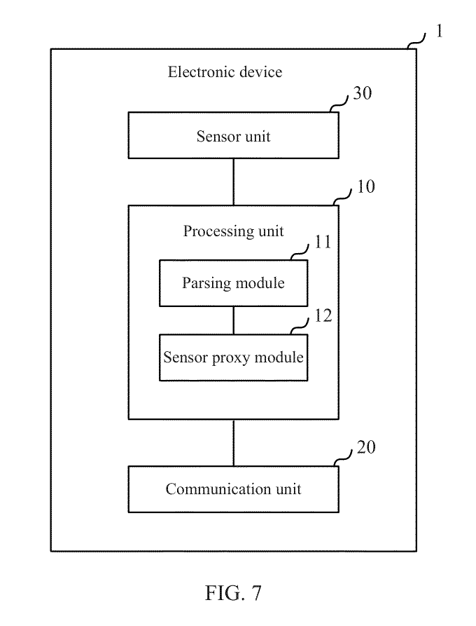

The electronic apparatus according to an embodiment of the present disclosure will be described with reference to FIG. 7. The electronic apparatus is preferably a smart phone, a personal computer, a tablet computer, etc.

As shown in FIG. 7, the electronic apparatus 1 according to the embodiment of the present disclosure has a processing unit 10, a communication unit 20 and a sensor unit 30. It is easily understood that, FIG. 7 only shows the components closely related to the present disclosure in order to simplify description. The electronic apparatus 1 according to the embodiment of the present disclosure may certainly include other components, such as a displaying unit, an input/output unit, etc.

Specifically, the processing unit 10 of the electronic apparatus 1 as shown in FIG. 7 is used for executing an operating system and at least one HTML5-based Web application.

The communication unit 20 is used for conducting a communication connection with other electronic apparatuses and servers via a network; the communication unit 20 may communicate with other electronic apparatuses and servers via the network in a wired or wireless manner, so as to exchange desired data and services with other electronic apparatuses and servers.

The sensor unit 30 includes, but not limited to, a gravity sensor, a gyroscope, an optical sensor, a magnetic field sensor, a temperature sensor, etc.

It is easily understood by those skilled in the art that, although FIG. 7 merely shows exemplarily a sensor unit 30, the electronic apparatus 1 according to the embodiment of the present disclosure may include two or more sensor units. In addition, it should be understood that, the electronic apparatus 1 according to the embodiment of the present disclosure may have no sensor unit, but may obtain the data of the sensor configured by a remote electronic apparatus connected therewith by the sensor data obtaining method according to an embodiment of the present disclosure.

In addition, as shown in FIG. 7, the processing unit 10 of the electronic apparatus 1 is further configured with a parsing module 11 and a sensor proxy module 12; in a preferable embodiment of the present disclosure, the parsing module 11 is used for receiving and parsing the sensor data request transmitted by the Web application executed by the processing unit 10, and obtaining the sensor application interface corresponding to the sensor data request.

The sensor proxy module 12 further inquires the local application interface, so as to determine whether a local application interface corresponding to the obtained sensor application interface parsed by the parsing module 11 exists or not; if the local application interface corresponding to the obtained sensor application interface exists, obtains the sensor data from the local application interface and provides it to the Web application; if the local application interface corresponding to the obtained sensor application interface does not exist, transmits the sensor data request including the obtained sensor application interface to the remote electronic apparatus via the communication unit 20, and receives the sensor data returned from the remote electronic apparatus.

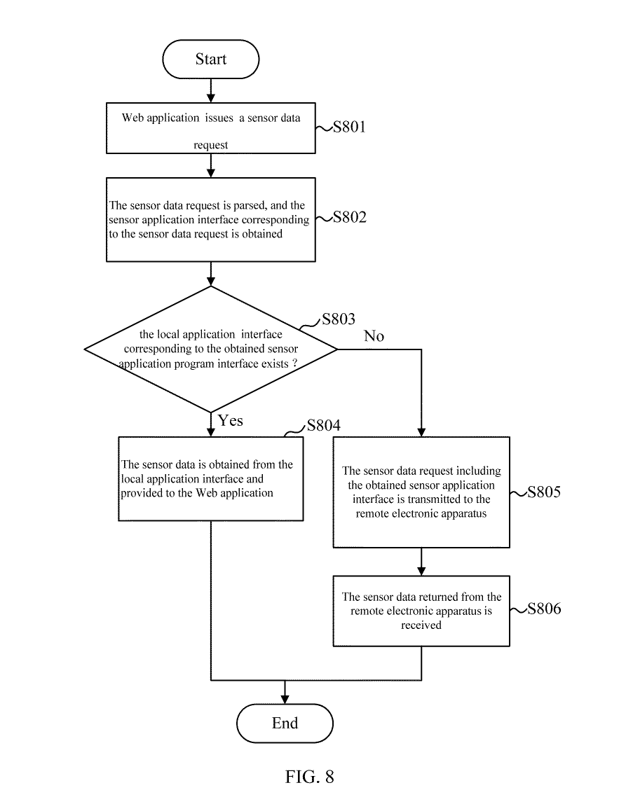

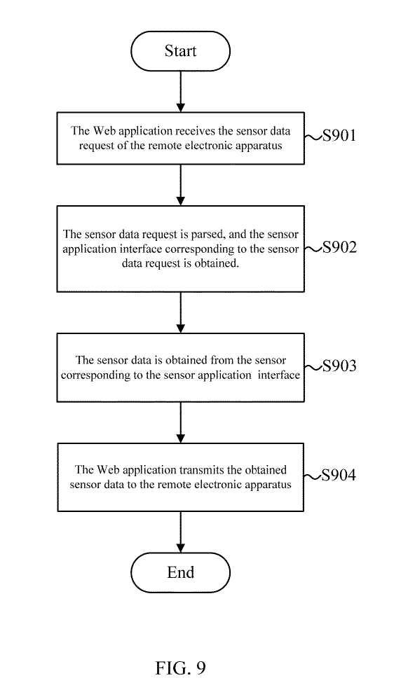

With reference now to FIG. 8 and FIG. 9, the sensor data obtaining method according to an embodiment of the present disclosure will be described.

FIG. 8 is a flow chart of a sensor data obtaining process of the sensor data obtaining method according to an embodiment of the present disclosure. As shown in FIG. 8, the sensor data obtaining process of the sensor data obtaining method according to the embodiment of the present disclosure includes steps as follows.

In step S801, Web application sends out a sensor data request. Here, the sensor data request is specifically sent out by the Web application executed by the processing unit 10.

In step S802, the sensor data request is parsed, and the sensor application interface corresponding to the sensor data request is obtained. Here, the parsing is specifically finished by the parsing module 11 in the processing unit 10. In a preferable embodiment of the present disclosure, the sensor application interface is an application program interface conforming to HTML5 specification.

In step S803, the local application interface is inquired to determine whether the local application interface corresponding to the obtained sensor application interface exists or not; if does, the process proceeds to step S804; otherwise, the process proceeds to step S805. Here, the inquiry is specifically finished by the sensor proxy module 12 in the processing unit 10. Specifically, if in step S803, it is determined that the local application interface corresponding to the obtained sensor application interface exists, i.e., the electronic apparatus 1 has a sensor resource required by the Web application, and then the process proceeds to step S804.

In step S804, the sensor data is obtained from the local application interface and provided to the Web application, hereinafter the sensor data obtaining process comes to an end. Here, the obtaining the sensor data is specifically completed by the sensor proxy module 12.

Inversely, if in step S803, it is determined that the local application interface corresponding to the obtained sensor application interface does not exist, i.e., the electronic apparatus 1 does not have a sensor resource required by the Web application or the Web application specifies to use a sensor resource of the specific remote electronic apparatus, then the process proceeds to step S805.

In step S805, the sensor data request including the obtained sensor application interface is transmitted to the remote electronic apparatus. Here, the sensor data request is specifically transmitted by the sensor proxy module 12 to the remote electronic apparatus via the communication unit 20.

In step S806, the sensor data returned from the remote electronic apparatus is received and provided to the Web application, hereinafter the sensor data obtaining process comes to an end. Here, the receiving is specifically completed by the sensor proxy module 12 via the communication unit 20.

The sensor data obtaining process of the sensor data obtaining method according to an embodiment of the present disclosure as shown in FIG. 8, may provide local sensor data or remote sensor data for the Web application as necessary, and the sensor data obtaining process is based on current HTML5 specification or an apparatus application interface defined by the HTML5 specification, without necessity of any augmentation or modification.

FIG. 9 is a flow chart of a sensor data providing process of the sensor data obtaining method according to an embodiment of the present disclosure. As shown in FIG. 9, the sensor data providing process of the sensor data obtaining method according to the embodiment of the present disclosure includes steps as follows.

In step S901, the sensor data request of the remote electronic apparatus is received. Here, the sensor data request is specifically received by the Web application executed by the processing unit 10 via the communication unit 20.

In step S902, the sensor data request is parsed, and the sensor application interface corresponding to the sensor data request is obtained. Here, the parsing is specifically completed by the parsing module 11 in the processing unit 10. As mentioned before, in a preferable embodiment of the present disclosure, the sensor application interface is an application interface conforming to HTML5 specification.

In step S903, the sensor data is obtained from the local application interface and provided to the Web application. Here, the obtaining sensor data is specifically completed by the sensor proxy module 12.

In step S904, the obtained sensor data is transmitted to the remote electronic apparatus. Here, the transmitting is completed by the Web application via the communication unit 20.

The sensor data providing process of the sensor data obtaining method according to the embodiment of the present disclosure as shown in FIG. 9, may provide local sensor data for the remote electronic apparatus which issues the sensor data request as necessary, and the sensor data obtaining process is based on current HTML5 specification or an apparatus application interface defined by the HTML5 specification, without necessity of any augmentation or modification.

The sensor data obtaining method and the electronic apparatus according to an embodiment of the present disclosure have been described above with reference to FIG. 7 to FIG. 9, which can obtain the sensor data of the local or remote apparatus in the HTML5 environment, without any modification to the current HTML5 specification or the apparatus API defined by the HTML5 specification.

It should be noted that, the steps in the methods described in conjunction with FIG. 8 and FIG. 9 can be implemented in combination with the method described in FIG. 1. For example, the step 104 in FIG. 1 can be implemented by using the method of FIG. 8 or FIG. 9. Specifically, the responding to the operation request with the first resource according to the operation request (104) may include: parsing the sensor data request, to obtain a sensor application interface corresponding to the sensor data request (S202); inquiring the local application interface (S203), if the local application interface corresponding to the obtained sensor application interface exists, obtaining the sensor data from the local application interface and providing it to the Web application (S204); if the local application interface corresponding to the obtained sensor application interface does not exist, transmitting the sensor data request including the obtained sensor application interface to the remote electronic apparatus (S205), and receiving the sensor data returned from the remote electronic apparatus (S206). Or the responding to the operation request with the first resource according to the operation request (104) may include: parsing the sensor data request, to obtain a sensor application interface corresponding to the sensor data request (S302); obtaining sensor data from the sensor corresponding to the sensor application interface (S303); transmitting, by the Web application, the obtained sensor data to the remote electronic apparatus (S304). Respective steps involved in FIG. 8 or FIG. 9 may be referred to the above description in conjunction with FIG. 8 and FIG. 9.

It should be noted that, the electronic apparatus described in conjunction with FIG. 7 can be implemented in combination with the electronic apparatus described in FIG. 5. For example, the responding unit 503 in FIG. 5 can be implemented by using the processing unit 10 and the communication unit 20 shown in FIG. 7. Specifically, the responding unit 503 in FIG. 5 may include: a processing unit 10, for operating at least one HTML5-based Web application; and a communication unit 20, for conducting a communication connection with a remote electronic apparatus via a network; wherein, the processing unit may further include a parsing module 11 and a sensor proxy module 12, the parsing module 11 can receive and parse the sensor data request transmitted by the Web application executed by the processing unit, obtain the sensor application interface corresponding to the sensor data request, and the sensor agent module 12 can inquire the local application interface, obtain the sensor data from the local application interface and provide it to the Web application if the local application interface corresponding to the obtained sensor application interface exists, transmit the sensor data request including the obtained sensor application interface to the remote electronic apparatus via the communication unit 20 if the local application interface corresponding to the obtained sensor application interface does not exist, and receive the sensor data returned from the remote electronic apparatus. Respective units involved in FIG. 7 may be referred to the above description in conjunction with FIG. 5.

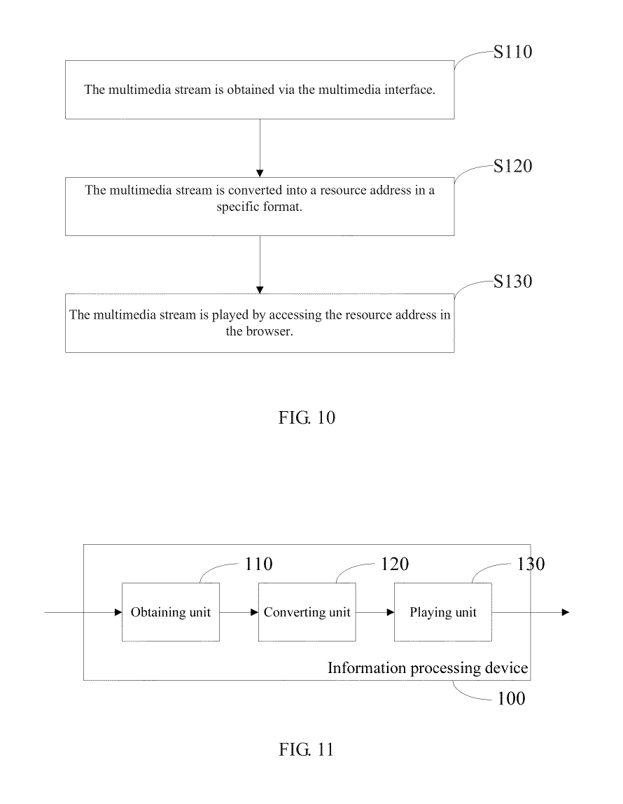

Hereinafter, the information processing method and the information processing device according to the present disclosure will be described with reference to FIG. 10 and FIG. 11.

FIG. 10 shows an information processing method of the present disclosure; and FIG. 11 shows an information processing device of the present disclosure.

The information processing method as shown in FIG. 10 is applied to an electronic apparatus, and is used for enabling a browser installed in the electronic apparatus to realize real-time play of multimedia stream. The information processing method is implemented by the information processing device as shown in FIG. 11. Specifically, the information processing device 100 includes: an obtaining unit 110, a converting unit 120, and a playing unit 130.

As shown in FIG. 10, the information processing method includes steps as follows.

In step S110, the multimedia stream is obtained by the multimedia interface. Here, the obtaining step is completed by the obtaining unit 110.

In step S120, the multimedia stream is converted into a resource address in a specific format. Here, the converting step is completed by the converting unit 120.

In step S130, the multimedia stream is played by accessing the resource address in the browser. Here, the playing step is completed by the playing unit 130.

It is thus seen that, by adopting the information processing method and the information processing device according to the present disclosure, the multimedia stream obtained by the multimedia interface may be converted into a resource address in a specific format, and the multimedia stream is played by accessing the resource address in the browser installed in the electronic apparatus. Therefore, in the present disclosure, accessing the multimedia stream by the browser can be implemented on the operating system platform of the electronic apparatus by using the framework and elements for realizing network real-time communication defined in WebRTC protocol.

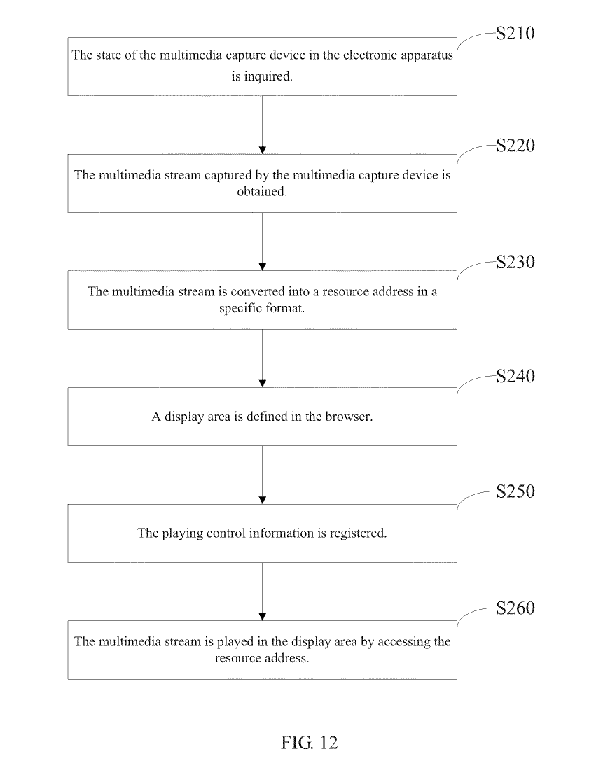

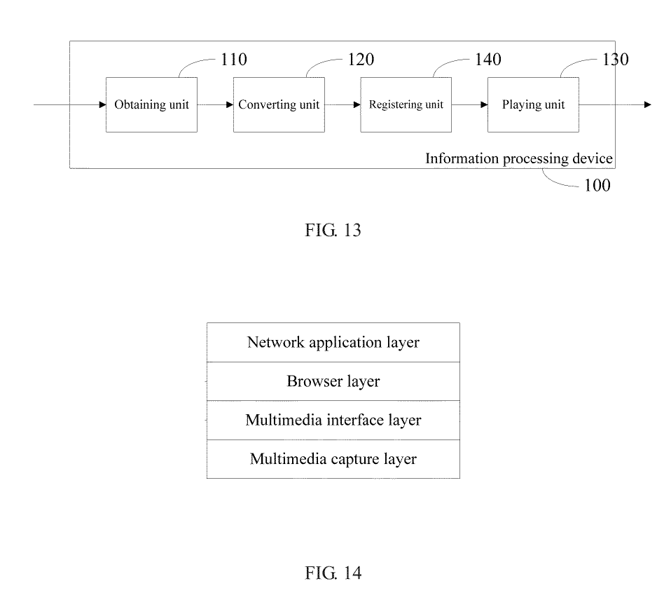

Hereinafter, the information processing method and the information processing device according to the present disclosure will be described with reference to FIG. 12 and FIG. 13.

FIG. 12 shows an information processing method according to an embodiment of the present disclosure; and FIG. 13 shows an information processing device 100 according to an embodiment of the present disclosure;

The information processing method as shown in FIG. 12 is implemented by the information processing device 100 in FIG. 13. As shown in FIG. 13, same as in FIG. 11, the information processing device 100 includes: an obtaining unit 110, a converting unit 120, and a playing unit 130. In addition, preferably, the information processing device 100 may also include: a registering unit 140.

The information processing device 100 may be applied to one or more electronic apparatuses; at least one operating system is installed in the electronic apparatus, and at least one browser is installed in the operating system. The information processing device 100 enables a browser installed in the electronic apparatus to realize real-time play of the multimedia stream captured by the multimedia capture device installed in the electronic apparatus or in other electronic apparatus connected with the electronic apparatus.

In a first example, the electronic apparatus may be a mobile phone; an Android operating system of Google Inc. can be installed in the mobile phone, and the browser may be a default browser equipped in the Android operating system, such as an Android browser.

In a second example, the electronic apparatus may be a personal computer; a Windows operating system of Microsoft may be installed in the personal computer; and the browser may be a default browser equipped in the Windows operating system, such as an Internet explorer (IE) browser.

In a third example, the electronic apparatus may be a tablet computer; an iOS operating system of Apple Inc. may be installed in the tablet computer, and the browser may be a default browser equipped in the iOS operating system, such as a safari browser.

In addition, the information processing device 100 may communicate with the electronic apparatus in any manner.

In one example, the information processing device 100 may be integrated into the electronic apparatus as a software module and/or a hardware device. In other words, the electronic apparatus may include the information processing device 100. For example, when the electronic apparatus is a mobile phone, the information processing device 100 may be a software module in the operating system of the mobile phone, or an application developed for the mobile phone; certainly, the information processing device 100 may also be one of the numerous hardware devices of the mobile phone.

Alternatively, in another example, the information processing device 100 may be a device separated from the electronic apparatus, and the information processing device 100 may be connected to the electronic apparatus by a wired and/or wireless network, and transmits control information according to the agreed data format.

In addition, the information processing device 100 has a framework used for realizing network real-time communication defined in a WebRTC protocol. The WebRTC protocol realizes a video conference based on webpage, with a standard of Web Hypertext Technology Working Group (WHATWG) protocol, and with an objective to achieve real-time communication just by the browser providing simple JavaScript. At first, such a framework of the WebRTC protocol will be briefly described below.

FIG. 14 shows a framework for realizing network real-time communication defined in WebRTC protocol.

As shown in FIG. 14, the WebRTC protocol includes four layers of framework, which are a multimedia capture layer, a multimedia interface layer, a browser layer, and a network application layer from bottom to up.

The multimedia capture layer is used for an operation of capturing multimedia stream. For example, the layer may be implemented by a multimedia capture device for providing a multimedia stream capture service equipped in the electronic apparatus.

The multimedia interface layer is used for providing an interface for obtaining the multimedia stream to the browser. For example, the layer may include a Navigator.getUserMedia method as defined in the WebRTC protocol. When the browser is expected to access the video stream separately, the general format of the method is as follows:

Navigator.getUserMedia({audio: true}, gotStream, noStream)

The semanteme thereof is that: when the video stream is obtained successfully, the operation defined in gotStream function is executed; when video stream obtaining fails, the operation defined in noStream function is executed. When the browser is expected to access an audio stream separately, the general format of the method is as follows:

Navigator.getUserMedia({audio: true}, gotStream, noStream)

Similarly, when the browser is expected to access a video stream and an audio stream simultaneously, the general format of the method is as follows:

Navigator.getUserMedia({audio: true, video: true}, gotStream, noStream)

The browser layer is an interface provided to the browser manufacturer, which facilitates the browser manufacturer implementing the Web API based on the WebRTC standard easily, so as to handle a digital signal process abstractly.

The network application layer is a WebRTC standard API provided for a third-party developer, so as to facilitate the developer to develop a Web application similar to online video chat easily.

The embodiment of the present disclosure will be described specifically below in the following scenes, wherein the electronic apparatus is a mobile phone using the Android operating system, and the browser is the default Android browser installed in the mobile phone, and the information processing method is applied so that the Android browser can access the video stream captured by the camera equipped in the mobile phone.

However, it should be illustrated that the present disclosure is not restricted thereto. The electronic apparatus may be any type of electronic apparatus, including but not limited to: a notebook computer, a tablet computer, a mobile phone, a multimedia player, a personal digital assistant, etc. The operating system may be any type of operating system, including but not limited to: Android, Windows, iOS, Linux, Window Phone (WP), etc. In the same way, besides the default browsers installed in the operating system platform in the electronic apparatus, the browser may further be any other type of browser. In addition, the information processing method according to the embodiment of the present disclosure may also be applied so that a browser installed in electronic apparatus can access the multimedia stream (such as audio stream, video stream, etc.) captured by one or more multimedia capture devices equipped in the electronic apparatus or in other electronic apparatus (such as a microphone, a camera, etc.).

As shown in FIG. 12, the information processing method according to an embodiment of the present disclosure includes steps as follows.

In step S210, a state of the multimedia capture device in the electronic apparatus is inquired.

In order that the browser (for example, the default Android browser) installed in the electronic apparatus (for example, a mobile phone) can realize real-time play of multimedia stream (for example, video stream) captured by one or more multimedia capture devices (for example, a camera) equipped in the electronic apparatus, the multimedia stream is obtained by the obtaining unit 110 via the multimedia interface in the information processing device 100. For example, in order to complete the obtaining operation, the obtaining unit 110 may include an inquiring module, an obtaining module and a memory module (not shown).

Firstly, the inquiring module inquires the state of a multimedia capture device in the electronic apparatus via a multimedia interface, and judges whether the multimedia capture device is in a working state or in a non-working state. In one embodiment, the multimedia interface may be the Navigator.getUserMedia method as defined in the WebRTC protocol mentioned above.

On one hand, if the multimedia capture device is in a working state, the inquiring module may notify the obtaining module to obtain the multimedia stream captured by the multimedia capture device. On the other hand, if the multimedia capture device is in a non-working state, the inquiring module may preferably prompt the user whether to open the multimedia capture device or not via the human-computer interaction interface (for example, a displayer, a loudspeaker, an indicator light, etc.) of the electronic apparatus.

Preferably, the obtaining unit 110 may further include a receiving module and a switching module (not shown). When the user chooses not to open the multimedia capture device according to the above prompt, the receiving module receives the choice of the user, and the information processing method according to the embodiment of the present disclosure comes to an end. When the user chooses to open the multimedia capture device according to the above prompt, the receiving module receives a state switch command generated according to the choice of the user, and notifies the switching module to switch the multimedia capture device from the non-working state to the working state according to the state switch command, so as to facilitate the subsequent operation.

In addition, preferably, the switching module may further judge whether the user making the current choice has the authority to execute operation on the multimedia capture device of the electronic apparatus or not, and only when the user is authorized, the above switching operation is executed.

In step S220, the multimedia stream captured by the multimedia capture device is obtained.

After a notification of acquiring multimedia stream is received from the inquiring module, the obtaining module obtains the multimedia stream captured by the multimedia capture device via the multimedia interface.

For example, when the browser is expected to access the video stream separately, the acquisition module commands the camera to start to capture the video stream. When the browser is expected to access the audio stream separately, the obtaining module commands the microphone to start to capture the audio stream. When the browser is expected to access the video stream and the audio stream simultaneously, the obtaining module commands the camera and the microphone to start to capture simultaneously.

Next, the memory module may store the multimedia stream in a memory address. For example, the memory module may be a buffer memory in the mobile phone, for caching the video stream captured by the camera. Or, the memory module may be a memory card in the mobile phone, for storing the video stream captured by the camera in a certain path.

Preferably, in order to improve the storage efficiency and the subsequent reading efficiency of the multimedia stream, the memory module may be a temporary memory module, for caching the multimedia stream in a plurality of memory addresses. For example, the temporary memory module may conduct caching of the multimedia stream in two memory addresses A and B alternatively.

In addition, preferably, the memory module may store context information related to the multimedia stream in the memory address, so as to facilitate calling in the displaying process later on. For example, the context information includes: identification information of the multimedia capture device for capturing the multimedia stream, resolution information (or the sampling rate information of the current audio stream), size information, and capture rate information of the multimedia stream.

In step S230, the multimedia stream is converted into a resource address in a specific format.

After the obtaining unit has obtained the multimedia stream via the multimedia interface, the converting unit 120 converts the multimedia stream into a resource address in a specific format. For example, in order to complete the converting, the converting unit 120 may include a generating module, a pairing module, and a registering module (not shown).

Firstly, the generating module generates the resource address of a specific format. For example, the specific format may be a binary large object (BLOB) format, and the resource address may be the source address (src) of the multimedia stream. In other words, the resource address of the specific format may be an address of blob format as defined by the browser.

Then, the pairing module pairs the memory address of the memory module for storing the multimedia stream with the resource address, and notifies the registering module to register the pairing in a mapping file. For example, the registering module may be used for recording the one-to-one corresponding relationship between the memory address and the resource address in a data table (for example, a mapping relation table), a database, or a registration file and so on.

In step S240, a display area is defined in the browser.

After the converting unit 120 has converted the multimedia stream into a resource address in a specific format, the playing unit 130 plays the multimedia stream by accessing the resource address in the browser. For example, in order to complete the playing, the playing unit 130 may include a defining module, an allocating module, and a playing module (not shown).

Firstly, the defining module may be a layout module in a browser, which is used for defining a display area in the browser according to location information and attribute information. For example, the location information indicates the positional coordinates of the display area in the displayed page of the browser, and the attribute information indicates the attributes such as size, shape of the display area, and whether to automatically play or not, etc.

Then, the allocating module allocates the resource address to the display area, so that the playing module can play the multimedia stream captured by the multimedia capture device.

Next, the playing module identifies the resource address allocated by the allocating module to the display area, and judges the format of the resource address. If the resource address does not have the above specific format, the information processing method according to the embodiment of the present disclosure comes to an end. If the resource address has the above specific format, the playing module inquires the memory address of the multimedia stream corresponding to the resource address in the mapping file. For example, the registered playing module may inquire the one-to-one corresponding relationship between the memory address and the resource address recorded in a data table, a database, or a registration file, and determine the memory address of the multimedia stream according to the resource address allocated by the allocating module.

Then, the playing module reads the multimedia stream from the memory address.

Preferably, the playing module reads the context information related to the multimedia stream from the memory address; then the playing module plays the multimedia stream in the display area according to the context information. For example, the playing module determines which multimedia capture device in the electronic apparatus is capturing the multimedia stream according to the identification information in the context information, and sets a display resolution, a display dimension and a display rate of the multimedia stream in the display area according to the resolution information, the size information and the capture rate information.

In step S250, the playing control information is registered.

Preferably, when the playing module has read the context information, preferably, the registration unit 140 may further register the playing control information for playing the multimedia stream, so as to define the playing of the multimedia stream in the display area. For example, the playing control information may include texture drawing information and media callback information.

The texture drawing information is information defined in the Android browser, which is used for specifying which layer is used for displaying the texture, i.e. the multimedia stream.

The media callback information may be a MediaCallbackFunction function defined in the WebRTC protocol, which is used for controlling the playing operation of the multimedia stream. The playing operation includes: playing, closing, adjusting the playing progress, pausing, and volume setting of the multimedia stream.

In step S260, the multimedia stream is played in the display area by accessing the resource address.

Finally, the playing module plays the multimedia stream by accessing the resource address in the display area according to the above playing control information. For example, the playing module may parse the playing control information registered by the registration unit 140, and display in the display area the multimedia stream read from the memory address, and display in the display area the control bar (for example, play, pause, fast forward, fast backward, close, playing progress bar, volume adjustment button) associated with the playing of the multimedia stream, so that the multimedia stream is played under the control of the user ultimately.

In practice, the information processing method and the information processing device may be implemented by a computer program code. Hereinafter, in a specific detailed embodiment, the information processing method and the information processing device according to the embodiment of the present disclosure are described.

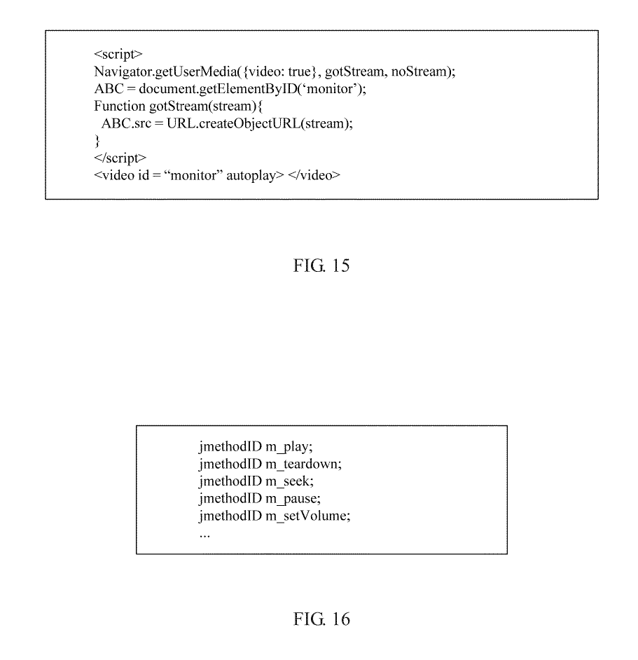

FIG. 15 shows an example of a program code for implementing the information processing method according to an embodiment of the present disclosure.

When a user wants to access the multimedia stream (for example, a video stream) captured by the multimedia capture device (for example, a camera) equipped in the electronic apparatus via a browser installed in the electronic apparatus (for example, a mobile phone), the user may firstly start the browser installed in the electronic apparatus. Then, the user may load and run the web page including the program code as shown in FIG. 5 in the browser, and the program code is used for implementing the information processing method according to the embodiment of the present disclosure.

In the running process of the program code, as mentioned above, Navigator.getUserMedia is the method defined in WebRTC protocol for obtaining the local video interface. When the Navigator.getUserMedia method is generated, since this function has been registered in the browser engine WebKit of Android, it is only necessary to generate a specific function webkitGetUserMedia( ).

In the running process of the function, a state of the camera apparatus of the Android system may be inquired (as mentioned in the above step S210), and the context information of the camera is obtained and recorded.

Then, if the running result of webkitGetUserMedia( ) indicates successful acquisition of the local video, the method continues to call the function gotStream( ), so as to continue the subsequent operation (as mentioned in the above step S220). If the running result of webkitGetUserMedia( ) indicates failure to acquire the local video, the method continues to call the function noStream( ), so as to prompt the user the failure of current playing operation.

Next, in gotStream( ), URL.createobjectURL(stream) function is used for interpreting the video stream into a URL of a specific format to express the stream (as mentioned in the above step S230), and the URL of the specific format is assigned to an src attribute of a variable ABC. For example, the format of the URL usually begins with “blob:”, and a specific module in the browser engine WebKit in Android is responsible for processing the URL of the blob format.

In the running process of URL.createObjectURL(stream), it is necessary to register the pairing between the stream and URL, which can be realized by adding the function BlobRegistryImpl::registerBlobURL(const KURL& url, PassOwnPtr<stream> stream) in the blobRegistryImpl.cpp file to complete registration in the bloburl manager.

Then, a video tag (with “monitor” as identifier) of HTML may be newly created and the video tag is assigned to the variable ABC, so as to define a display area for playing the video stream (as mentioned in the above step S240). And in the video tag, the stream is played.

Specifically, in the video tag, when the identified URL is a blob URL, the browser will search the corresponding video stream in bloburl manager, and return the stream; then just assign the context of the stream to a function corresponding to the video tag. When the assigning operation has been completed, the following values of the texture drawing information (drawtexture) and media callback information (mediacallbackfunction) may be further registered (as mentioned in the above step S250).

FIG. 16 shows the media callback information defined in WebRTC protocol.

As shown in FIG. 16, the MediaCallbackFunction function includes method identifiers (ID) such as m_play, m_teardown, m_seek, m_pause, m_setVolume, etc., which are respectively used for controlling the playing, closing, adjusting the playing progress, pausing, and volume setting of the multimedia stream.

Finally, the video stream may be played automatically in the video tag according to the above playing control information, on the basis of the autoplay attribute of the video tag (as mentioned in the above step S260).

It is thus seen that, by adopting the information processing method and the information processing device according to the present disclosure, the state of the multimedia capture device in the electronic apparatus may be inquired via the multimedia interface; when the multimedia capture device is in a working state; the multimedia stream captured by the multimedia capture device is obtained via the multimedia interface, the multimedia stream obtained thereby may be converted into a resource address in a specific format, a display area is defined in the browser, the playing control information is registered, and finally, the multimedia stream is played in the display area according to the playing control information by accessing the resource address. Therefore, in the present disclosure, it truly realizes the network real-time communication framework and elements defined in WebRTC protocol, so that the developer may easily develop abundant real-time multimedia applications by using HTML5, without downloading and installing any plug-ins, and the Web developer need not pay attention to the digital signal processing procedure of the multimedia content, but only need code simple JavaScript program, which ultimately facilitate the user to access the local and/or remote audio and/or video stream in the browser by the existing HTML tag (for example, a video tag).

It should be noted that, the steps in the methods described in conjunction with FIG. 10 and FIG. 12 can be implemented in combination with the method described in FIG. 1. For example, the step 104 in FIG. 1 can be implemented by using the method of FIG. 10. Specifically, the responding to the operation request with the first resource according to the operation request (104) may include: obtaining the multimedia stream as first resource by the multimedia interface (S110); converting the multimedia stream into a resource address in a specific format (S120); playing the multimedia stream by accessing the resource address in the browser (S130). Respective steps involved in FIG. 10 may be referred to the above description in conjunction with FIG. 10 and FIG. 12.

It should be noted that, the information processing device described in conjunction with FIG. 11 can be implemented in combination with the electronic apparatus described in FIG. 5. For example, the responding unit 503 in FIG. 5 can be implemented by using the respective units of the information processing device described in FIG. 11. Specifically, the responding unit 503 in FIG. 5 may include: an obtaining unit 110, for obtaining the multimedia stream via the multimedia interface; a converting unit 120, for converting the multimedia stream into a resource address in a specific format; and a playing unit 130, for playing the multimedia stream by accessing the resource address in the browser. Respective units involved in FIG. 11 may be referred to the above description in conjunction with FIG. 11 and FIG. 13.

Those ordinarily skilled in the art can understand that all or part of the steps of the method for implementing the above embodiments can be performed by either hardware, or program instruction-related hardware; and the corresponding program can be stored in a computer-readable storage medium, such as ROM, magnetic disk or optical disk, etc.

The present disclosure is described above with reference to the preferred embodiments thereof, which is not used for limiting the present invention. It should be recognized that the present disclosure is not limited to the above embodiments. Any modification, equivalent replacement, improvement, etc. without departing from the spirit and principle of the present disclosure should be deemed as being included within the scope.

1. A method for implementing a local operation on a web page applied to an electronic apparatus that includes a displaying unit and the electronic apparatus has a HyperText Markup Language (HTML) operating environment, wherein the method comprises:
loading a web page by address information in the HTML operating environment;
obtaining identification information for representing a status of local resources of the electronic apparatus in the process of loading the web page;
obtaining an operation request, the operation request being used for representing a request for operating a first resource in the local resources;
responding to the operation request with the first resource according to the operation request; and
displaying a responding result of the responding to the operation request with the first resource on the displaying unit.

2. The method according to claim 1, wherein, the responding to the operation request with the first resource according to the operation request comprises:
when a javascript engine parses a first interface corresponding to the operation request in a render progress, the javascript engine being for interpreting a javascript script, the first interface being an interface self-defined based on javascript and being for operating the first resource on the web page, and the first interface is registered in the javascript engine, the javascript engine transmitting an inter-process communication (IPC) message to a host process according to the first interface, to request for operating the local first resource on the web page; and
calling a local interface to operate the local first resource on the web page according to the received IPC message during the host process;
wherein, the render progress is in a protected state and has no authority to call the local interface; the host process is in a non-protected state and has an authority to call the local interface.

3. The method according to claim 2, wherein, the javascript engine transmitting the IPC message to the host process according to the first interface to request for operating the local first resource on the web page comprises:
mapping, by the javascript engine, the first interface as a local function able to be run in the render process; and
running the local function, and transmitting the IPC message to the host process, to request for operating the local first resource on the web page.

4. The method according to claim 2, wherein, the method further comprises:
judging whether the web page has an authority to operate the local resources or not according to a preset white list, before the javascript engine transmitting the inter-process communication (IPC) message to the host process according to the first interface; and
executing the step of the javascript engine transmitting the IPC message to the host process according to the first interface, if it is determined that the web page has the authority to operate the local resources.

5. The method according to claim 1, wherein, the electronic apparatus includes a sensor, the obtained operation request is a sensor data request received from a remote electronic apparatus which is connected with the electronic apparatus, the responding to the operation request with the first resource according to the operation request comprises:
parsing the sensor data request and obtaining a sensor application interface corresponding to the sensor data request;
obtaining sensor data from the sensor corresponding to the sensor application interface; and
transmitting, by a Web application, the obtained sensor data to the remote electronic apparatus.

6. The method according to claim 1, wherein, the HTML operating environment is an HTML5 operating environment, the obtained operation request is a sensor data request transmitted by the Web application, the responding to the operation request with the first resource according to the operation request comprises:
parsing the sensor data request and obtaining a sensor application interface corresponding to the sensor data request; and
inquiring a local application interface, if the local application interface corresponding to the obtained sensor application interface exists, obtaining the sensor data from the local application interface and providing the sensor data to the Web application; if the local application interface corresponding to the obtained sensor application interface does not exist, transmitting the sensor data request including the obtained sensor application interface to the remote electronic apparatus, and receiving the sensor data returned from the remote electronic apparatus.

7. The method according to claim 1, wherein the method enables a browser installed in the electronic apparatus to realize real-time play of multimedia stream, and the responding to the operation request with the first resource according to the operation request comprises:
obtaining a multimedia stream as the first resource via a multimedia interface;
converting the multimedia stream into a resource address in a specific format; and
playing the multimedia stream by accessing the resource address in the browser.

8. The method according to claim 7, wherein, the step of obtaining a multimedia stream via a multimedia interface includes:
inquiring a state of a multimedia capture device in the electronic apparatus via the multimedia interface;
obtaining the multimedia stream captured by the multimedia capture device via the multimedia interface, when the multimedia capture device is in a working state; and
storing the multimedia stream in a memory address.

9. The method according to claim 8, wherein, the step of converting the multimedia stream into the resource address in the specific format includes:
generating the resource address;
pairing the memory address with resource address; and
registering the pairing in a mapping file.

10. The method according to claim 9, wherein, the step of playing the multimedia stream by accessing the resource address in the browser includes:
defining a display area in the browser according to location information and attribute information;
allocating the resource address to the display area; and
playing the multimedia stream by accessing the resource address in the display area.

11. The method according to claim 10, wherein, the step of playing the multimedia stream by accessing the resource address in the display area includes:
judging whether the resource address allocated to the display area has a specific format or not;
if the resource address allocated to the display area has a specific format, inquiring the memory address of the multimedia stream corresponding to the resource address in the mapping file;
reading the multimedia stream from the memory address; and
displaying the multimedia stream in the display area.

12. A device for implementing a local operation on a web page, wherein, the device is applied to an electronic apparatus that has a HyperText Markup Language (HTML) operating environment, the device comprises:
a loading unit, for loading a web page according to address information in the HTML operating environment;
an obtaining unit, for obtaining identification information for representing a status of local resources of the electronic apparatus, in the process of loading the web page;
a responding unit, for obtaining an operation request, and responding to the operation request with the first resource according to the operation request, the operation request being used for representing a request for operating a first resource in the local resources; and
a displaying unit, for displaying a responding result of the responding to the operation request with the first resource.

13. The device according to claim 12, wherein, the responding unit comprises:
a javascript engine, for interpreting a javascript script when a first interface corresponding to the operation request is parsed in a render progress, wherein the first interface is an interface self-defined based on javascript and is used for operating the first resource on the web page, and the first interface is registered in the javascript engine, and for transmitting an inter-process communication (IPC) message to a host process according to the first interface, to request for operating the local first resource on the web page; and
a local calling subunit, for calling a local interface to operate the local first resource on the web page according to the received IPC message during the host process;
wherein, the render progress is in a protected state and has no authority to call the local interface; the host process is in a non-protected state and has an authority to call the local interface.

14. The device according to claim 13, wherein, the javascript engine is used for:
mapping the first interface as a local function able to be run in the render process; and
running the local function, transmitting the IPC message to the host process, to request for operating the local first resource on the web page.

15. The device according to claim 13, wherein, the javascript engine is further used for:
judging whether the web page has an authority to operate the local resources or not according to a preset white list, before transmitting an inter-process communication (IPC) message to a host process according to the first interface; and
executing the step of the javascript engine transmitting the IPC message to the host process according to the first interface, if it is determined that the web page has the authority to operate the local resources.

16. The device according to claim 12, wherein, the HTML operating environment is an HTML5 operating environment, and the responding unit comprises:
a processing unit, for running at least one HTML5-based Web application and including a parsing module and a sensor proxy module; and
a communication unit, for conducting a communication connection with a remote electronic apparatus via a network;
where, the parsing module receives and parses a sensor data request transmitted from the Web application run by the processing unit, and obtains a sensor application interface corresponding to the sensor data request, and the sensor proxy module inquires a local application interface, if the local application interface corresponding to the obtained sensor application interface exists, the sensor proxy module obtains sensor data from the local application interface and provides the sensor data to the Web application, if the local application interface corresponding to the obtained sensor application interface does not exist, the sensor proxy module transmits the sensor data request including the obtained sensor application interface to the remote electronic apparatus via the communication unit, and receives the sensor data returned from the remote electronic apparatus.

17. The device according to claim 16, wherein, the electronic apparatus further comprises a sensor unit,
wherein, the Web application run by the processing unit receives the sensor data request of the remote electronic apparatus via the communication unit, obtains the sensor data from a sensor corresponding to the sensor application interface, and the Web application transmits the obtained sensor data to the remote electronic apparatus via the communication unit.

18. The device according to claim 12, wherein, the device enables a browser installed in the electronic apparatus to realize real-time play of multimedia stream, the responding unit comprises:
an obtaining unit, for obtaining a multimedia stream via a multimedia interface;
a converting unit, for converting the multimedia stream into a resource address in a specific format; and
a playing unit, for playing the multimedia stream by accessing the resource address in the browser.

19. The device according to claim 18, wherein, the obtaining unit comprises:
an inquiring module, for inquiring a state of a multimedia capture device in the electronic apparatus via the multimedia interface;
an obtaining module, for obtaining the multimedia stream captured by the multimedia capture device via the multimedia interface, when the multimedia capture device is in a working state; and
a memory module, for storing the multimedia stream in a memory address.

20. The device according to claim 19, wherein, the converting unit comprises:
a generating module, for generating the resource address;
a pairing module, for pairing the memory address with the resource address; and
a registering module, for registering the pairing in a mapping file.

21. The device according to claim 20, wherein, the playing unit comprises:
a defining module, for defining a display area in the browser according to location information and attribute information;
an allocating module, for allocating the resource address to the display area; and
a playing module, for playing the multimedia stream by accessing the resource address in the display area.

22. The device according to claim 21, wherein, the playing module judges whether the resource address allocated to the display area has a specific format or not, inquires the memory address of the multimedia stream corresponding to the resource address in the mapping file if does, reads the multimedia stream from the memory address, and displays the multimedia stream in the display area.

23. A device for implementing a local operation on a web page, wherein, the device is applied to an electronic apparatus, the electronic apparatus has a HyperText Markup Language (HTML) operating environment, the device comprises:
a javascript engine, for parsing a web page in the render process when the web page is opened in the HTML operating environment; for transmitting an inter-process communication (IPC) message to a host process to request for operating the local first resource on the web page when a first interface is parsed, wherein the first interface is an interface self-defined based on javascript and is used for operating the first resource on the web page, and the first interface is registered in the javascript engine; and
a local calling module, for calling a local interface to operate the local first resource on the web page according to the received IPC message during the host process;
wherein, the render progress is in a protected state and has no authority to call the local interface; the host process is in a non-protected state and has an authority to call the local interface.

24. The device according to claim 23, wherein, the javascript engine is used for:
mapping the first interface as a local function able to be run in the render process;
running the local function, and transmitting the IPC message to the host process, to request for operating the local first resource on the web page.
